(19) United States
(12) Patent Application Publication
(10) Pub. No.: US 2025/0022130 A1
(43) Pub. Date: Jan. 16, 2025

(54) APPARATUS AND METHOD FOR IMPROVING INTER-SLICE RESOLUTION IN 3D MEDICAL IMAGING

(71) Applicant: Claripi Inc., Seoul (KR)

(72) Inventors: Dong Ok KIM, Goyang-si (KR); Jong Hyo Kim, Seoul (KR)

(21) Appl. No.: 18/771,565

(22) Filed: Jul. 12, 2024

(30) Foreign Application Priority Data
Jul. 13, 2023 (KR) 10-2023-0091367

(51) Int. Cl. G06T 7/00

(52) U.S. Cl. CPC G06T 7/0012; G06T 2207/20081

(57) ABSTRACT

According to the disclosure, the image generating module generates a second multi-slice medical image set having a low resolution in a preset direction by reconstructing a first multi-slice medical image set received from an outside to have a cutting plane perpendicular to a slice plane in the preset direction, generates a third multi-slice medical image set, of which a resolution is improved as much as an integer multiple in the preset direction in slice images included in the second multi-slice medical image set through a deep learning model trained in advance by inputting the second multi-slice medical image set to the deep learning model, and generates and outputs a 3D high-resolution image improved in resolution based on the third multi-slice medical image set.

### CROSS REFERENCE TO RELATED APPLICATION

Priority to Korean patent application number 10-2023-0091367 filed on Jul. 13, 2023 the entire disclosure of which is incorporated by reference herein, is claimed.

### BACKGROUND OF THE INVENTION

### Field of the Invention

The disclosure relates to an apparatus and method for improving an inter-slice resolution of a 3D medical image, and more particularly to an apparatus and method for improving an inter-slice resolution of a 3D medical image, in which the 3D medical image is improved in resolution.

### Description of the Related Art

In general, an X-ray, a computed tomography (CT), a magnetic resonance imaging (MRI), and the like medical apparatuses are used to acquire medical images. In modern medicine, the medical images acquired through such medical apparatuses are used as a very important basis for the presence and characteristics of lesions to make decisions in a process of diagnosing and treating a patient.

The art related to medical: image processing has already been disclosed in “Korean Patent Publication No. 2014-0134903 (Method and apparatus for improving quality medical image, Nov. 15, 2014).” This related art is to remove noise from medical images and provide high-quality medical images to reading doctors.

In particular, with the advancement of artificial intelligence (AI) technology, various technologies are being researched and developed in medical industry to convert low-quality medical images into high-quality medical images. As a method of generating high-quality medical images, there are a de-noising method of removing noise from a medical image as disclosed in the related art, a super resolution (SR) method of reconstructing a low resolution (LR) image into a high resolution (HR) image, etc.

However, the resolution of the 3D medical image has a lower inter-plane (Inter-Plane) resolution of the slice compared to the intra-plane (Intra-plane) resolution of the slice included in the medical image. It is known that research and development on ways to improve is insufficient.

### SUMMARY OF THE INVENTION

An aspect of the disclosure is to provide an apparatus and method for improving an inter-slice resolution of a 3D medical image, in which a 3D medical image with an inter-plane resolution lower than an intra-plane resolution is improved.

According to an embodiment of the disclosure, an apparatus for improving an inter-slice resolution of a 3D medical image includes an image generating module configured to improve a resolution of the 3D medical image, of which an inter-plane resolution of slices is lower than an intra-plane resolution, wherein the image generating module is configured to: generate a second multi-slice medical image set having a low resolution in a preset direction by reconstructing a first multi-slice medical image set received from an outside to have a cutting plane perpendicular to a slice plane in the preset direction, generate a third multi-slice medical image set, of which a resolution is improved as much as an integer multiple in the preset direction in slice images included in the second multi-slice medical image set through a deep learning model trained in advance by inputting the second multi-slice medical image set to the deep learning model, and generate and output a 3D high-resolution image improved in resolution based on the third multi-slice medical image set.

The deep learning model may include a plurality of deep learning models trained based on different pieces of scan information, and the second multi-slice medical image set may be input to the deep learning model selected corresponding to a scan information among the plurality of deep learning models by acquiring the scan information from the second multi-slice medical image set, upon inputting the second multi-slice medical image to the deep learning model.

The deep learning model may be trained based on a pair of medical image sets different in resolution from each other, the pair of medical image sets may include a normal-quality medical image set and a low-quality medical image set, and the deep learning model may allow the third multi-slice medical image set of normal quality to be output, upon inputting the second multi-slice medical image set of low quality.

In the generation of the pair of medical images, the normal-quality medical image set acquired from a medical apparatus may be converted into the low-quality medical image set, and in the conversion into the low-quality medical image set, the low-quality medical image set may include a slice image, of which a resolution is degraded as much as an integer multiple in the preset direction.

In the output of the 3D high-resolution image, a cutting plane set cut perpendicularly in a slice direction of the first multi-slice medical image set may be reconstructed for the third multi-slice medical image set.

In the generation of the second multi-slice medical image set, a first sub-set may be reconstructed to have a cutting plane on a slice plane in a first predetermined direction based on the first multi-slice medical image set, a second sub-set may be reconstructed to have a cutting plane on a slice plane in a second predetermined direction different from the first predetermined direction based on the second multi-slice medical image set, and the reconstruction of the first and second sub-sets may be repeated so that the second multi-slice medical image set can have a plurality of sub-sets.

In the generation of the third multi-slice medical image, the second multi-slice medical image set including the plurality of sub-sets may be input to the deep learning model trained in advance, and the plurality of sub-sets may be each improved in resolution in the predetermined direction as much as an integer multiple through the deep learning model so that the third multi-slice medical image set can have a plurality of sub-sets.

In the output of the 3D high-resolution image, a cutting plane set vertical cut in a slice direction of the first multi-slice medical image set may be reconstructed for each sub-set of third multi-slice medical image set including the plurality of sub-sets, and an average image of the reconstructed cutting plane set images from each sub set may be output.

Meanwhile, a method of improving an inter-slice resolution of a 3D medical image, which improves a resolution of the 3D medical image, of which an inter-plane resolution of slices is lower than an intra-plane resolution includes: generating a second multi-slice medical image set having a low resolution in a preset direction by reconstructing a first multi-slice medical image set received from an outside to have a cutting plane perpendicular to a slice plane in the preset direction; generating a third multi-slice medical image set, of which a resolution is improved as much as an integer multiple in the preset direction in slice images included in the second multi-slice medical image set through a deep learning model trained in advance by inputting the second multi-slice medical image set to the deep learning model; and generating and outputting a 3D high-resolution image improved in resolution based on the third multi-slice medical image set.

The deep learning model may include a plurality of deep learning models trained based on different pieces of scan information, and the second multi-slice medical image set may be input to the deep learning model selected corresponding to a scan information among the plurality of deep learning models by acquiring the scan information from the second multi-slice medical image set, upon inputting the second multi-slice medical image to the deep learning model. The deep learning model may be trained based on a pair of medical image sets different in resolution from each other, the pair of medical image sets may include a normal-quality medical image set and a low-quality medical image set, and the deep learning model may allow the third multi-slice medical image set of normal quality to be output, upon inputting the second multi-slice medical image set of low quality.

In the generation of the pair of medical images, the normal-quality medical image set acquired from a medical apparatus may be converted into the low-quality medical image set, and in the conversion into the low-quality medical image set, the low-quality medical image set may include a slice image, of which a resolution is degraded as much as an integer multiple in the preset direction.

In the output of the 3D high-resolution image, a cutting plane set cut perpendicularly in a slice direction of the first multi-slice medical image set may be reconstructed for the third multi-slice medical image set.

In the generation of the second multi-slice medical image set, a first sub-set may be reconstructed to have a vertical cutting plane on a slice plane in a first predetermined direction based on the first multi-slice medical image set, a second sub-set may be reconstructed to have a vertical cutting plane on a slice plane in a second predetermined direction different from the first predetermined direction based on the second multi-slice medical image set, and the reconstruction of the first and second sub-sets may be repeated so that the second multi-slice medical image set can have a plurality of sub-sets.

In the generation of the third multi-slice medical image, the second multi-slice medical image set including the plurality of sub-sets may be input to the deep learning model trained in advance, and the plurality of sub-sets may be each improved in resolution in the predetermined direction as much as an integer multiple through the deep learning model so that the third multi-slice medical image set can have a plurality of sub-sets.

In the output of the 3D high-resolution image, a cutting plane set perpendicularly cut in a slice direction of the first multi-slice medical image set may be reconstructed for each sub-set of third multi-slice medical image set including the plurality of sub-sets, and an average image of the reconstructed cutting plane set images from each sub set may be output.

As described above, an apparatus and method for improving an inter-slice resolution of a 3D medical image have effects on providing a high-quality 3D medical image to a reading doctor by improving the resolution of the 3D medical image, of which an inter-plane resolution of slices is lower than an intra-plane resolution of slices.

The technical effects of the disclosure are not limited to the aforementioned effects, and other unmentioned technical effects may become apparent to those skilled in the art from the following description.

### BRIEF DESCRIPTION OF THE DRAWINGS

FIG. 1 is a conceptual view schematically showing voxels of a 3D medical image according to an embodiment,

FIG. 2 is a block diagram schematically showing an apparatus for improving an inter-slice resolution of a 3D medical image according to an embodiment,

FIG. 3 is a flowchart showing a method of improving an inter-slice resolution of a 3D medical image according to an embodiment,

FIG. 4 is a conceptual view showing a method of improving an inter-slice resolution of a 3D medical image according to an embodiment,

FIG. 5 is a flowchart showing a training method of a deep learning model loaded in an apparatus for improving an inter-slice resolution of a 3D medical image according to an embodiment,

FIG. 6 is a conceptual view showing a training method of a deep learning model loaded in an apparatus for improving an inter-slice resolution of a 3D medical image according to an embodiment,

FIG. 7 is a flowchart showing a method of improving

an inter-slice resolution of a 3D medical image according to another embodiment, and

FIG. 8 is a conceptual view showing a method of improving an inter-slice resolution of a 3D medical image according to another embodiment.

### DETAILED DESCRIPTION OF THE INVENTION

Hereinafter, embodiments of the disclosure will be described in detail with reference to the accompanying drawings. However, the disclosure is not limited to the embodiments set forth herein, but may be implemented in various different ways. The embodiments are provided to only complete the disclosure and allow those skilled in the art to understand the category of the disclosure. In the accompanying drawings, the shape, etc. of an element may be exaggerated for clear description, and like numerals refer to like elements.

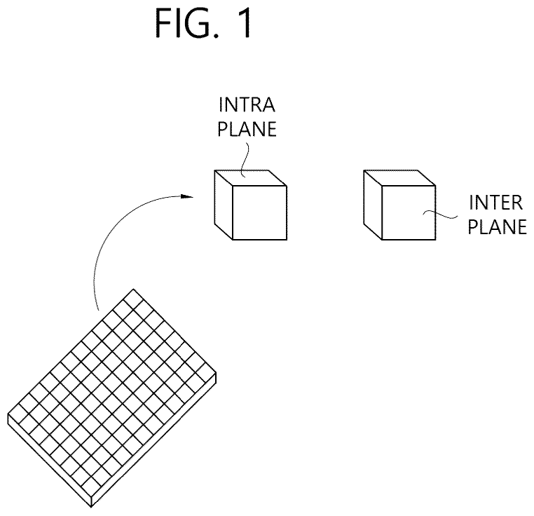

FIG. 1 is a conceptual view schematically showing voxels of a 3D medical image according to an embodiment, and

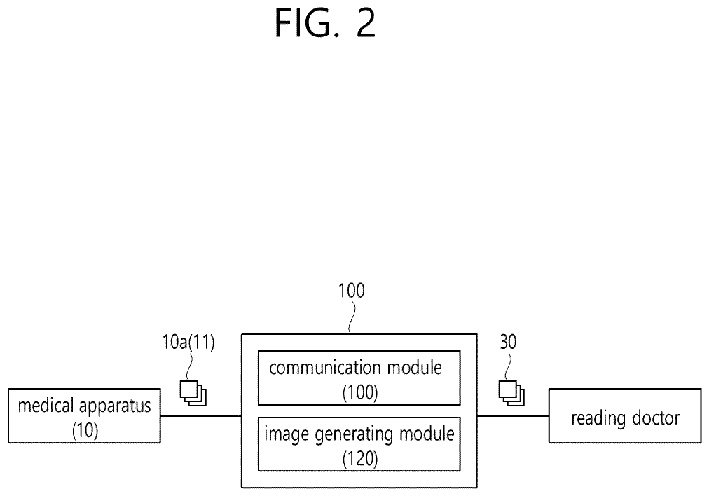

FIG. 2 is a block diagram schematically showing an apparatus for improving an inter-slice resolution of a 3D medical image according to an embodiment.

As shown in FIGS. 1 and 2, an apparatus for improving an inter-slice resolution of a 3D medical image according to an embodiment (hereinafter referred to as an image generating apparatus) may improve the resolution of a medical image data 10a acquired from a medical apparatus 10, and transmit a 3D high-resolution image 30 to a reading doctor.

Here, the medical apparatus 10 may include a computed tomography (CT) apparatus, a magnetic resonance imaging (MRI) apparatus, and a positron emission tomography (PET) apparatus, etc., but there are no limits to the types of medical apparatus 10 and medical image data 10a.

However, the medical image data 10a provided by an image generating apparatus 100 may include a 3D medical image of which an inter-plane resolution of slices is lower than an intra-plane resolution. In other words, the medical image data 10a includes a volume cell (Voxel) having a thickness, in which the voxel refers to a square pillar that has horizontal and vertical lengths corresponding to pixel spacing, and a height corresponding to a slice thickness. Here, the voxel may be 3D numerical information, for example, volumetric data in Hounsfield units, about a body part corresponding to each square pillar,

Thus, according to an embodiment, the 3D medical image of which an inter-plane resolution of slices is lower than an intra-plane resolution may refer to an image in which the inter-plane resolution of the voxel is lower than the intra-plane pixel spacing of the slice.

Meanwhile, the image generating apparatus 100 may include a communication module 110 and an image generating module 120. Here, the communication module 110 and the image generating module 120 may be provided as elements independent of each other, but may be provided together in a single computer system.

First, the communication module 110 receives the medical image data 10a, which may be provided through the medical device 10 or a server (not shown). Here, the medical image data 10a may include a first multi-slice medical image set 11 including a plurality of slices, as the 3D medical image.

In addition, the image generating module 120 inputs the first multi-slice medical image set 11, which is provided through the communication module 110, to a deep learning model 200 trained in advance, and improve the resolution of the first multi-slice medical image set 11. Here, the image generating module 120 may include, but not limited to, a storage (not shown) where the medical image data 10a and the deep learning model 200 are stored, and a processor (not shown) where the medical image data 10a is processed based on the stored deep learning model 200.

Below, the method of improving the resolution of the medical image data will be described in detail with reference to the accompanying drawings. However, the foregoing elements will not be repetitively described, and assigned with the same reference numerals.

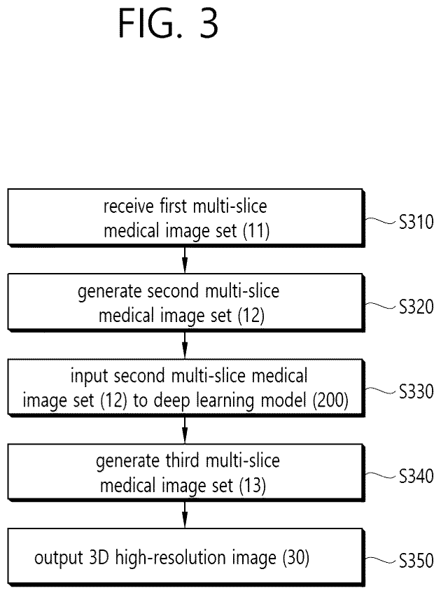

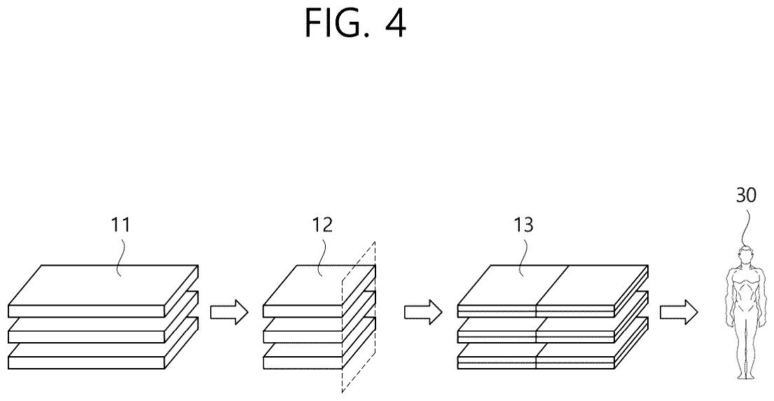

FIG. 3 is a flowchart showing a method of improving an inter-slice resolution of a 3D medical image according to an embodiment, and FIG. 4 is a conceptual view showing a method of improving an inter-slice resolution of a 3D medical image according to an embodiment.

As shown in FIGS. 3 and 4, the image generating module 120 according to an embodiment may receive the first multi-slice medical image set 11 from the communication module 110 (S310).

Accordingly, the image generating module 120 generates a second multi-slice medical image set 12 based on the input first multi-slice medical image set 11 (S320).

For example, the image generating module 120 may generate the second multi-slice medical image set 12, of which the resolution is relatively low, based on the slices included in the input first multi-slice medical image set 11.

For example, the image generating module 120 may reconstruct the slices to have a cutting plane perpendicular to a slice plane in a preset direction based on the first multi-slice medical image set 11. Accordingly, the resolution of the second multi-slice medical image set 12 is lowered with respect to at least one of the horizontal and vertical axes of the reconstructed slice image.

Here, the image generating module 120 may reconstruct the first multi-slice medical image set 11 to have the cutting plane perpendicular to the slice plane based on the deep learning model trained in advance, but there are no limits to the reconstruction methods and means.

Then, the image generating module 120 may input the second multi-slice medical image set 12, which has the cutting plane perpendicular to the slice plane, to the deep learning model 200 trained in advance (S330), and generate a third multi-slice medical image set 13 improved in resolution (S340).

For example, the image generating module 120 inputs the second multi-slice medical image set 12 to the deep learning model 200, and generate the third multi-slice medical image set 13 of which the resolution is improved as much as an integer multiple in the direction corresponding to the cutting plane in the slice images included in the second multi-slice medical image set 12.

For example, the deep learning model 200 may improve the resolution with respect to at least one of the horizontal and vertical axes in each of the slice images included in the second multi-slice medical image set 12.

Meanwhile, the image generating module 120 may select one of the plurality of deep learning models trained in advance in the process of inputting the second multi-slice medical image set 12 into the deep learning model 200, and input the second multi-slice medical image set 12 to the selected deep learning model.

For example, the image generating module 120 may acquire scan information included in the first multi-slice medical image set 11 provided through the communication module 110. Then, the image generating module 120 may select the deep learning model corresponding to the scan information among the plurality of deep learning models based on the scan information acquired from the first multi-slice medical image set 11, and output the third multi-slice medical image set 13 from the second multi-slice medical image set 12.

Here, the plurality of deep learning models may refer to the deep learning models trained to output the third multi-slice medical image set 13 improved in resolution from the second multi-slice medical image set 12 based on the different pieces of scan information.

However, this embodiment shows that the plurality of deep learning models is constructed based on the scan information, and the third multi-slice medical image set 13 is output based on the second multi-slice medical image set 12 through the deep learning model 200 corresponding to specific scan information included in the provided medical image data including. This is merely to describe an embodiment, and the plurality of deep learning models may be constructed according to various purposes and the characteristics of the medical image and applied selectively.

Meanwhile, a method of training the deep learning model loaded to an image processing apparatus according to an embodiment will be described below in detail with reference to the accompanying drawings.

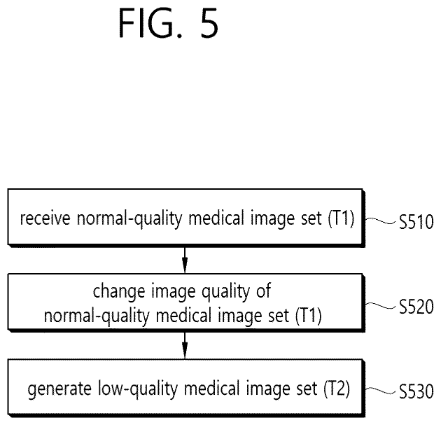

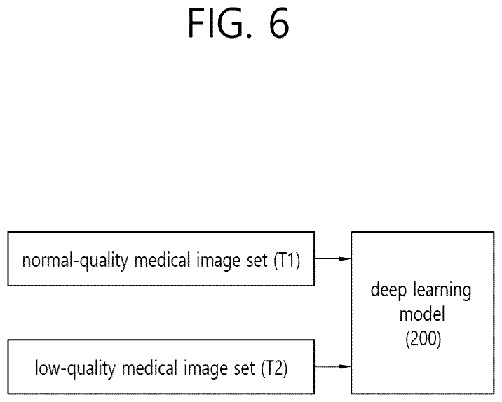

FIG. 5 is a flowchart showing a training method of a deep learning model loaded in an apparatus for improving an inter-slice resolution of a 3D medical image according to an embodiment, and FIG. 6 is a conceptual view showing a training method of a deep learning model loaded in an apparatus for improving an inter-slice resolution of a 3D medical image according to an embodiment,

As shown in FIGS. 5 and 6, the plurality of deep learning models according to an embodiment may be each trained based on a pair of medical image sets T1 and T2 different in resolution from each other.

For example, the plurality of deep learning models may include a first deep learning model trained with a first setting value acquired by a first scan method, and a second deep learning model trained with a second setting value acquired by a second scan method, according to the medical apparatuses or the scan information.

In addition, each deep learning model 200 is trained with a pair of a normal-quality medical image set T1 and a low-quality medical image set T2, thereby outputting a medical image data with an original resolution when the medical image data with a low resolution is input.

In training the deep learning model 200, the normal-quality medical image set T1 is received from the outside (S510). Then, the image quality of the normal-quality medical image set T1 is arbitrarily degraded (S520) to generate the low-quality medical image set T2 (S530).

For example, in training the deep learning model 200, the slices included in the normal-quality medical image set T1 having a first resolution, e.g., an original resolution acquired by the medical apparatus 10 may be converted into the low-quality medical image set T2 having a second resolution, e.g., a resolution lower than the first resolution. In this case, the low-quality medical image set T2 may be decreased in resolution with respect to at least one of the horizontal and vertical axes of the slices based on the normal-quality medical image set T1.

Then, the deep learning model 200 is trained with the pair of the normal-quality medical image set T1 and the low-quality medical image set T2 generated from the normal-quality medical image set T1.

Thus, when the second multi-slice medical image set 12 having a low resolution in the preset direction is input, the deep learning model 200 may generate the third multi-slice medical image set 13 of which the resolution is improved as much as an integer multiple in the preset direction.

Meanwhile, referring back to FIGS. 3 and 4, the image generating module 120 converts the second multi-slice medical image set 12 into the third multi-slice medical image set 13 based on the deep learning model 200 selected from among the plurality of deep learning models.

In addition, the image generating module 120 may output the 3D high-resolution image 30 improved in resolution based on the third multi-slice medical image set 13 (S350).

For example, the image generating module 120 may improve the resolution of the 3D medial image, in which the inter-plane resolution of the slice is lower than the intra-plane resolution, by reconstructing a cutting plane set, which is vertically cut in the slice direction of the first multi-slice medical image set 11, for the third multi-slice medical image set 13.

Meanwhile, a method of improving an inter-slice resolution of a 3D medical image according to another embodiment will be described below. However, the foregoing elements will not be repetitively described, and assigned with the same reference numerals.

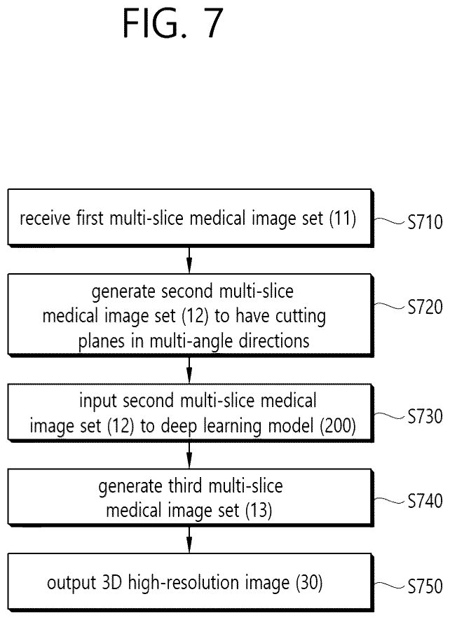

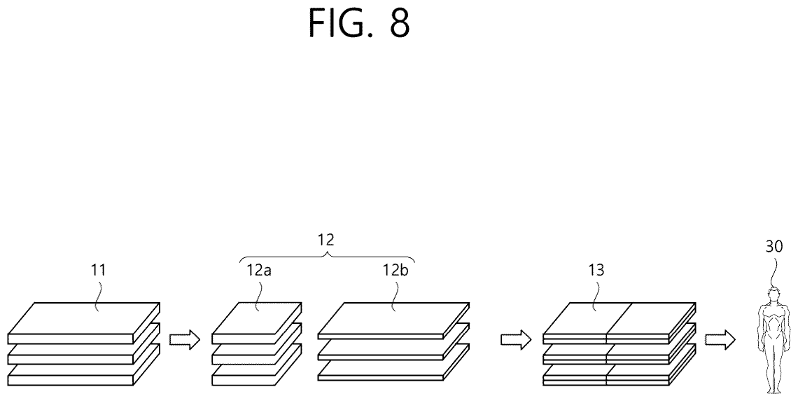

FIG. 7 is a flowchart showing a method of improving an inter-slice resolution of a 3D medical image according to another embodiment, and FIG. 8 is a conceptual view showing a method of improving an inter-slice resolution of a 3D medical image according to another embodiment.

As shown in FIGS. 7 and 8, according to this embodiment, the image generating module 120 receives the first multi-slice medical image set 11 from the communication module 110 (S710).

In addition, the image generating module 120 generates the second multi-slice medical image set 12 based on the received first multi-slice medical image set 11 (S720).

For example, the image generating module 120 may generate the second multi-slice medical image set 12 having low resolutions in multi-angle directions by reconstructing the first multi-slice medical image set 11 to have cutting planes to the slice plane in the multi-angle directions.

For example, the image generating module 120 may reconstruct the slices to have the cutting planes in the multi-angle directions, which includes a vertical direction or a horizontal direction, to the input slice plane based on the first multi-slice medical image set 11.

For example, the image generating module 120 reconstructs a first sub-set 12a have a cutting plane perpendicular to the slice plane in a first predetermined direction, e.g., a vertical direction based on the first multi-slice medical image set 11. In addition, the image generating module 120 reconstructs a second sub-set 12b to have a cutting plane in a second predetermined direction different from the first predetermined direction, e.g., a horizontal direction based on the first multi-slice medical image set 11. Here, the image generating module 120 may repeat the reconstruction of the first and second sub-sets so that the second multi-slice medical image set 12 can include a plurality of sub-sets.

Then, the image generating module 120 may generate the third multi-slice medical image set 13 based on the second multi-slice medical image set 12 including a plurality of sub-sets.

For example, the image generating module 120 inputs the second multi-slice medical image set 12 to the deep learning model 200 trained in advance (S730).

Here, the deep learning model 200 reconstructs the cutting plane set, which is cut in the slice direction of the first multi-slice medical image 11, for each sub-set in the third multi-slice medical image set 13 including a plurality of sub-sets (S740).

For example, the deep learning model 200 allows the first sub-set having the cutting plane in the first predetermined direction to be improved in resolution as much as an integer multiple in a direction corresponding to the first predetermined direction, and allows the second sub-set having the cutting plane in the second predetermined direction to be improved in resolution as much as an integer multiple in a direction corresponding to the second predetermined direction.

Then, the image generating module 120 may output the 3D high-resolution image 30 based on the third multi-slice medical image set 13 in which the resolution of the sub-set is improved as much as an integer multiple (S750).

For example, the image generating module 120 may reconstruct the cutting plane set cut in the slice direction of the first multi-slice medical image 11 with respect to each sub-set in the third multi-slice medical image set 13 including the plurality of sub-sets. In addition, the image generating module 120 may output an average image of the cutting plane set images reconstructed from each sub-set, and improve the resolution of the 3D medical image of which the inter-plane resolution of the slice is lower than the intra-plane resolution.

Although a few embodiments of the disclosure have been described above and illustrated in the accompanying drawings, the embodiments should not be construed as limiting the technical spirit of the disclosure. The scope of the disclosure is limited only by the subject matters disclosed in the appended claims, and the technical spirit of the disclosure may be modified and changed in various forms by a person having ordinary knowledge in the art. Therefore, such modification and change obvious to those skilled in the art will fall within the scope of the disclosure.

What is claimed is:

1. An apparatus for improving an inter-slice resolution of a 3D medical image, the apparatus comprising:
an image generating module configured to improve a resolution of the 3D medical image, of which an inter-plane resolution of slices is lower than an intra-plane resolution,
wherein the image generating module is configured to:
generate a second multi-slice medical image set having a low resolution in a preset direction by reconstructing a first multi-slice medical image set received from an outside to have a cutting plane perpendicular to a slice plane in the preset direction,
generate a third multi-slice medical image set, of which a resolution is improved as much as an integer multiple in the preset direction in slice images included in the second multi-slice medical image set through a deep learning model trained in advance by inputting the second multi-slice medical image set to the deep learning model, and
generate and output a 3D high-resolution image improved in resolution based on the third multi-slice medical image set.

2. The apparatus of claim 1, wherein
the deep learning model comprises a plurality of deep learning models trained based on different pieces of scan information, and
the second multi-slice medical image set is input to the deep learning model selected corresponding to a scan information among the plurality of deep learning models by acquiring the scan information from the second multi-slice medical image set, upon inputting the second multi-slice medical image to the deep learning model.

3. The apparatus of claim 1, wherein
the deep learning model is trained based on a pair of medical image sets different in resolution from each other,
the pair of medical image sets comprises a normal-quality medical image set and a low-quality medical image set, and
the deep learning model allows the third multi-slice medical image set of normal quality to be output, upon inputting the second multi-slice medical image set of low quality.

4. The apparatus of claim 3, wherein,
in the generation of the pair of medical images, the normal-quality medical image set acquired from a medical apparatus is converted into the low-quality medical image set, and
in the conversion into the low-quality medical image set, the low-quality medical image set comprises a slice image, of which a resolution is degraded as much as an integer multiple in the preset direction.

5. The apparatus of claim 1, wherein, in the output of the 3D high-resolution image, a cutting plane set cut perpendicularly in a slice direction of the first multi-slice medical image set is reconstructed for the third multi-slice medical image set.

6. The apparatus of claim 1, wherein, in the generation of the second multi-slice medical image set,
a first sub-set is reconstructed to have a cutting plane on a slice plane in a first predetermined direction based on the first multi-slice medical image set,
a second sub-set is reconstructed to have a cutting plane on a slice plane in a second predetermined direction different from the first predetermined direction based on the second multi-slice medical image set, and
the reconstruction of the first and second sub-sets is repeated so that the second multi-slice medical image set can have a plurality of sub-sets.

7. The apparatus of claim 6, wherein, in the generation of the third multi-slice medical image,
the second multi-slice medical image set comprising the plurality of sub-sets is input to the deep learning model trained in advance, and the plurality of sub-sets are each improved in resolution in the predetermined direction as much as an integer multiple through the deep learning model so that the third multi-slice medical image set can have a plurality of sub-sets.

8. The apparatus of claim 7, wherein in the output of the 3D high-resolution image,
a cutting plane set cut in a slice direction of the first multi-slice medical image set is reconstructed for each sub-set of third multi-slice medical image set comprising the plurality of sub-sets, and
an average image of the reconstructed cutting plane set images from each sub set is output.

9. A method of improving an inter-slice resolution of a 3D medical image, which improves a resolution of the 3D medical image, of which an inter-plane resolution of slices is lower than an intra-plane resolution, the method comprising:
generating a second multi-slice medical image set having a low resolution in a preset direction by reconstructing a first multi-slice medical image set received from an outside to have a cutting plane perpendicular to a slice plane in the preset direction;
generating a third multi-slice medical image set, of which a resolution is improved as much as an integer multiple in the preset direction in slice images included in the second multi-slice medical image set through a deep learning model trained in advance by inputting the second multi-slice medical image set to the deep learning model; and
generating and outputting a 3D high-resolution image improved in resolution based on the third multi-slice medical image set.

10. The method of claim 9, wherein
the deep learning model comprises a plurality of deep learning models trained based on different pieces of scan information, and
the second multi-slice medical image set is input to the deep learning model selected corresponding to a scan information among the plurality of deep learning models by acquiring the scan information from the second multi-slice medical image set, upon inputting the second multi-slice medical image to the deep learning model.

11. The method of claim 9, wherein
the deep learning model is trained based on a pair of medical image sets different in resolution from each other,
the pair of medical image sets comprises a normal-quality medical image set and a low-quality medical image set, and
the deep learning model allows the third multi-slice medical image set of normal quality to be output upon inputting the second multi-slice medical image set of low quality.

12. The method of claim 11, wherein,
in the generation of the pair of medical images, the normal-quality medical image set acquired from a medical apparatus is converted into the low-quality medical image set, and
in the conversion into the low-quality medical image set, the low-quality medical image set comprises a slice image, of which a resolution is degraded as much as an integer multiple in the preset direction.

13. The method of claim 9, wherein, in the output of the 3D high-resolution image, a cutting plane set cut perpendicularly in a slice direction of the first multi-slice medical image set is reconstructed for the third multi-slice medical image set.

14. The method of claim 9, wherein, in the generation of the second multi-slice medical image set,
a first sub-set is reconstructed to have a vertical cutting plane on a slice plane in a first predetermined direction based on the first multi-slice medical image set,
a second sub-set is reconstructed to have a vertical cutting plane on a slice plane in a second predetermined direction different from the first predetermined direction based on the second multi-slice medical image set, and
the reconstruction of the first and second sub-sets is repeated so that the second multi-slice medical image set can have a plurality of sub-sets.

15. The method of claim 14, wherein, in the generation of the third multi-slice medical image,
the second multi-slice medical image set comprising the plurality of sub-sets is input to the deep learning model trained in advance, and the plurality of sub-sets are each improved in resolution in the predetermined direction as much as an integer multiple through the deep learning model so that the third multi-slice medical image set can have a plurality of sub-sets.

16. The method of claim 15, wherein in the output of the 3D high-resolution image,
a cutting plane set perpendicularly cut in a slice direction of the first multi-slice medical image set is reconstructed for each sub-set of third multi-slice medical image set comprising the plurality of sub-sets, and
an average image of the reconstructed cutting plane set images from each sub set is output.
